(19) United States
(12) Patent Application Publication
(10) Pub. No.: US 2018/0049376 A1
(43) Pub. Date: Feb. 22, 2018

(54) PLANT PROPAGATION TRAY ASSEMBLY

(71) Applicant: Niall MAGEE, Belfast (GB)

(72) Inventor: Niall MAGEE, Belfast (GB)

(21) Appl. No.: 15/676,276

(22) Filed: Aug. 14, 2017

(30) Foreign Application Priority Data
Aug. 17, 2016 (GB) 1614059.2

(51) Int. Cl. A01G 9/10; A01G 9/02

(52) U.S. Cl. CPC A01G 9/104; A01G 9/027

(57) ABSTRACT

A propagation tray assembly comprising a support tray and a plurality of seedling holder inserts locatable in the support tray in side by side relationship, each insert comprising a row of cells, each cell having an open top and an open side to facilitate inspection and removal of the contents thereof when the respective insert is removed from the support tray, wherein the open sides of each cell in a first insert are closed by the adjacent insert when the inserts are located in the support tray in side by side relationship.

### CROSS-REFERENCE TO RELATED APPLICATIONS

This application makes a claim of priority under 35 USC 119 to United Kingdom patent application GB 1614059.2, filed on 17 Aug. 2016, which is incorporated herein by reference as if fully recited.

### FIELD OF THE INVENTION

This invention relates to plant propagation tray assembly for growing seedlings.

### BACKGROUND OF THE INVENTION

Seeds are commonly germinated in trays containing a compost and the seedlings are then transplanted for growing on into trays partitioned into an array of individual cells, one plant in each cell, wherein the seedlings are grown until they are of a sufficient size for planting into larger pots or into the soil.

A problem with this process is the difficulty in removing the seedlings from the cells of the trays once of a sufficient size for potting into larger pots or into the soil. Extracting each seedling from its respective cell is time consuming and fiddly and the seedlings are prone to damage during extraction. Typically the seedlings are spooned out of the cells using a spoon or a pair of knives to scoop out the seedling from the cell in which it is located. An alternative method is to insert a probe like tool into a drainage hole in the bottom of each cell to push out the seedling.

Another problem with known plant propagation methods is the difficulty in monitoring the condition of the seedlings, in particular the root system thereof during growth in the cells. It is desirable to check the health of the seedlings during the growing period to allow early identification and removal of diseased / infected seedlings to prevent spread and thus further losses.

An object of the present invention is to provide an improved propagation tray assembly that overcomes the abovementioned problems of the prior art.

### SUMMARY OF THE INVENTION

According to the present invention there is provided a propagation tray assembly comprising a support tray and a plurality of seedling holder inserts locatable in the support tray in side by side relationship, each insert comprising a row of cells, each cell having an open top and an open side to facilitate inspection and removal of the contents thereof when the respective insert is removed from the support tray, wherein the open sides of the cells in a first insert are closed by the adjacent insert when the inserts are located in the support tray in side by side relationship.

This greatly facilitates removal of the seedlings from the support tray, whereby each insert can be removed individually from the support tray and the seedlings can be easily removed from the holders via the open second side of each holder.

Each cell of each insert may comprise a first side wall, opposing second and third side walls extending perpendicular to the first side walls, the open side of each cell being located opposite said first side wall thereof. The first side walls of the cells of each insert are preferably arranged in a respective common plane, the first side walls of each insert closing the open side of the cells of an adjacent insert when the inserts are located within the support tray. In one embodiment the first side walls of the cells in a respective insert may be defined by a common wall extending the length of the respective insert, said common wall closing the open sides of the cells of an adjacent insert when the inserts are located in the support tray.

In one embodiment said first, second and third walls of each cell are tapered towards a base wall thereof to allow a plurality of inserts to be stacked together. The first walls of the cells of each insert may each comprise a tapered first wall portion defining a rear wall of the respective cell and a substantially vertical second wall portion depending from an upper edge of said first wall portion, said second wall portions of each insert being arranged to close the open side of the cells of an adjacent insert when the inserts are located within the support tray.

In an alternative embodiment the first, second and side walls of each cell are arranged substantially vertically so that each cell has a substantially cuboid shape.

The second and third side walls of the cells of each insert may comprise partition walls separating the cells of each insert.

A drainage hole may be provided in a base wall of each cell of each insert.

In one embodiment each insert may be releasably couplable to an adjacent insert. Interlocking coupling devices may be integrally formed on each insert to enable adjacent inserts to be coupled together. Alternatively clips or other fastening device may be provided for coupling adjacent inserts to one another.

### BRIEF DESCRIPTION OF THE DRAWINGS

A plant propagation tray assembly in accordance with an embodiment of the present invention will now be described, by way of example only, with reference to the accompanying drawings, in which:

FIG. 1 is a perspective view of a plant propagation tray assembly in accordance with an embodiment of the present invention;

FIG. 2 is a side view of an insert of the tray assembly of FIG. 1;

FIG. 3 is a perspective view of an insert of the tray assembly of FIG. 1;

FIGS. 4 to 6 illustrate the tray assembly of FIG. 1 in use;

FIG. 7 is a sectional view on line A-A of FIG. 2 of an insert of the tray assembly in accordance with one embodiment of the present invention;

FIG. 8 is a sectional view on line A-A of FIG. 2 of an insert of the tray assembly in accordance with a modified embodiment of the present invention; and

FIGS. 9 to 11 illustrate a further embodiment of the present invention wherein the inserts are capable of being coupled to one another.

### DETAILED DESCRIPTION OF THE DRAWINGS

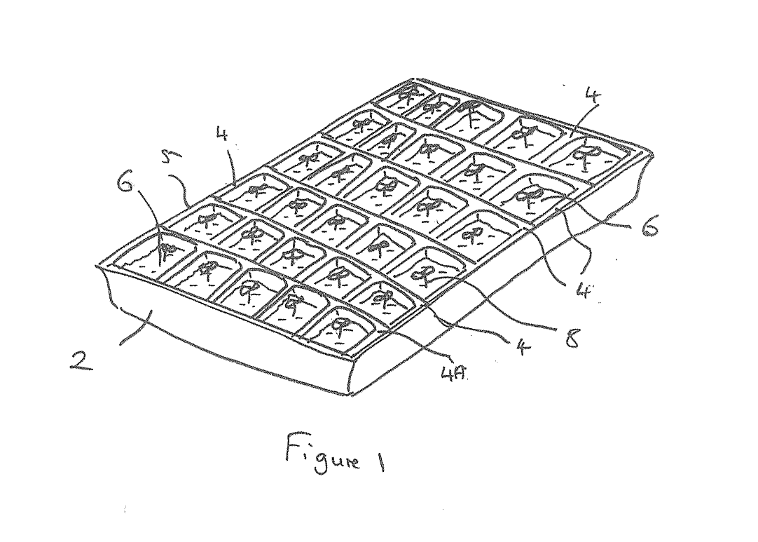

As shown in the drawings, and particularly FIG. 1, a plant propagation tray assembly in accordance with an embodiment of the present invention comprises a rectangular base tray 2, having a base and upstanding side walls, within which is located a number of inserts 4 (six in the embodiment shown, although any other number of inserts is envisaged) are located in side by side relationship, each insert 4 comprises a row of cells 6 (five cells in each insert in the embodiment shown, although any other number of cells is envisaged) within which individual seedlings 8 may be placed in a suitable growth medium.

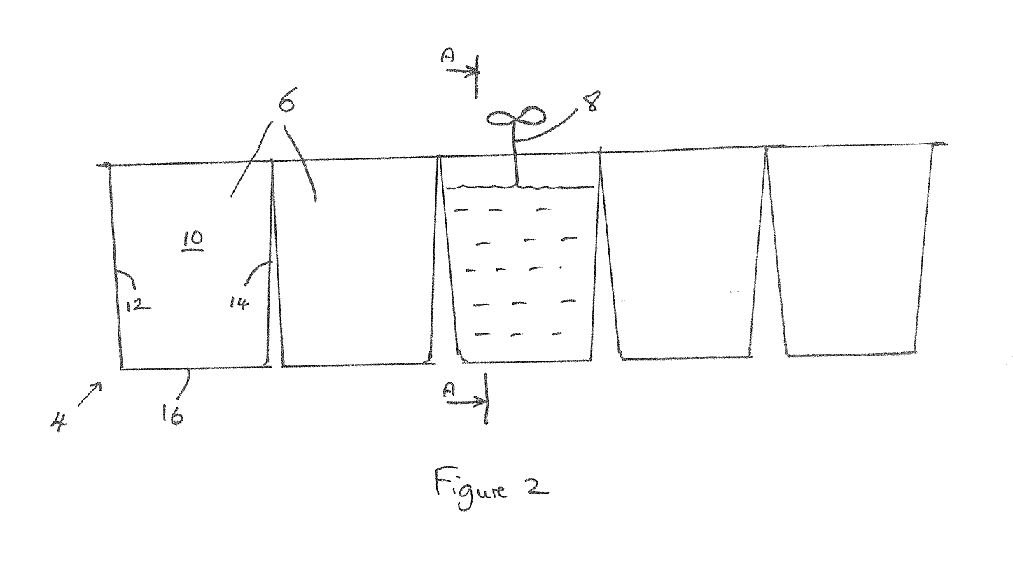

As best shown in FIGS. 2 and 3, each cell 6 of each insert 4 has an open top and an open front side to facilitate inspection and removal of the contents thereof when the respective insert is removed from the support tray 2, wherein the open sides of the cell 6 of each insert 4 are closed by the side walls of an adjacent insert when the inserts 4 are located in the support tray 2 in side by side relationship, or by an end wall of the tray 2 in the case on an endmost insert 4A.

Each cell 6 of each insert 4 comprises a first side wall 10, opposing second and third side walls 12,14 extending perpendicular to the first side walls 10, and a base wall 16. The open side of each cell 6 is located opposite said first side wall 10 thereof. The first side walls 10 of the cells of each insert 4 are aligned in a common plane, and may be defined by a common wall extending the length of the respective insert 4. The first walls 10 of the cells of each insert 4 also serve to close the open sides of the cells of an adjacent insert 4 when the inserts 4 are located in the support tray 2. The ends of each insert incorporate upper lips 5 arranged to rest upon an upper edge of the support tray when the inserts 4 are located in the support tray 2, supporting the inserts 4 within the support tray 2 and facilitating removal of the inserts 4.

The second and third side walls 14,16 of the cells 6 of each insert 4 may comprise common partition walls separating the cells 6 of each insert 4.

A drainage hole 18 may be provided in the base wall 16 of each cell 6 of each insert 4.

In use, the inserts 4 are placed in the support tray 2 in side by side relationship and a seedling 8 and a portion of a suitable growing medium are placed into each cell 6 of each insert 4. During growth, the condition of each seedling 8 may be readily inspected by lifting a respective insert 4 out of the support tray 2, exposing the open side of each cell 6 thereof. Any diseased or infected seedling may be readily removed and/or replaced before the respective insert 4 is replaced into its place in the support tray 2.

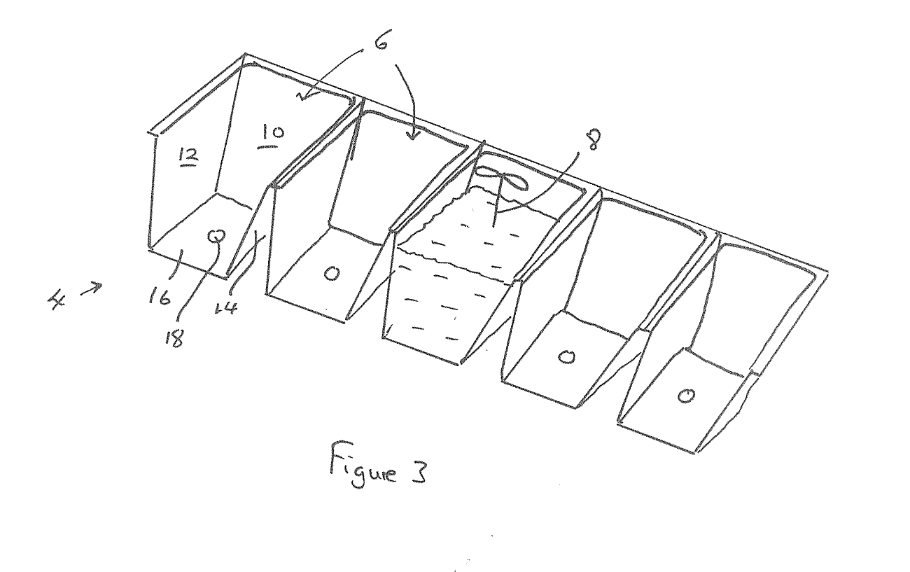

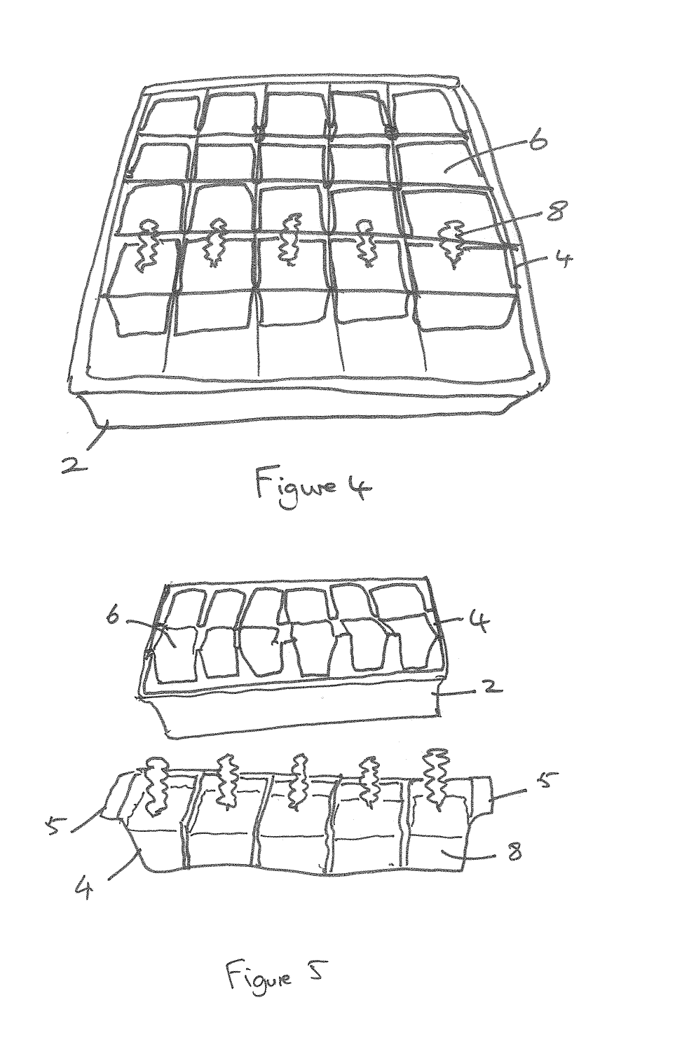

As shown in FIGS. 4 to 6, when it is desired to remove the seedlings from the cells 6 of each insert 4, for repotting in larger pots or for planting into the soil, each insert 4 in turn may be readily lifted out of the support tray 2 and may be tipped forwardly to allow the seedlings 8 in each cell 6 of the respective row to be tipped out from the open sides of the cells 6, as illustrated in FIG. 6.

As shown in FIG. 7, in one embodiment the first walls of each cell 6 of each insert 4 may be formed from a first wall portion 10B defining a rear wall of the respective cell 6, said first wall 10B being slightly inclined to the vertical, and a second wall portion 10A, defining a common vertical rear wall of the insert 6, said second wall portion 10A fitting against and closing the open side of a respective cell 6 of an adjacent insert 4. The second and third side walls 12,14 may be similarly inclined to give each cell a tapered shape, narrowing towards the base wall 16 thereof. This arrangement of tapered interior walls of each cell allows the inserts 6 to be supplied in stacked configuration, while the vertical second wall portion 10A ensures reliable closing of the open side of a respective cell of an adjacent insert thereby.

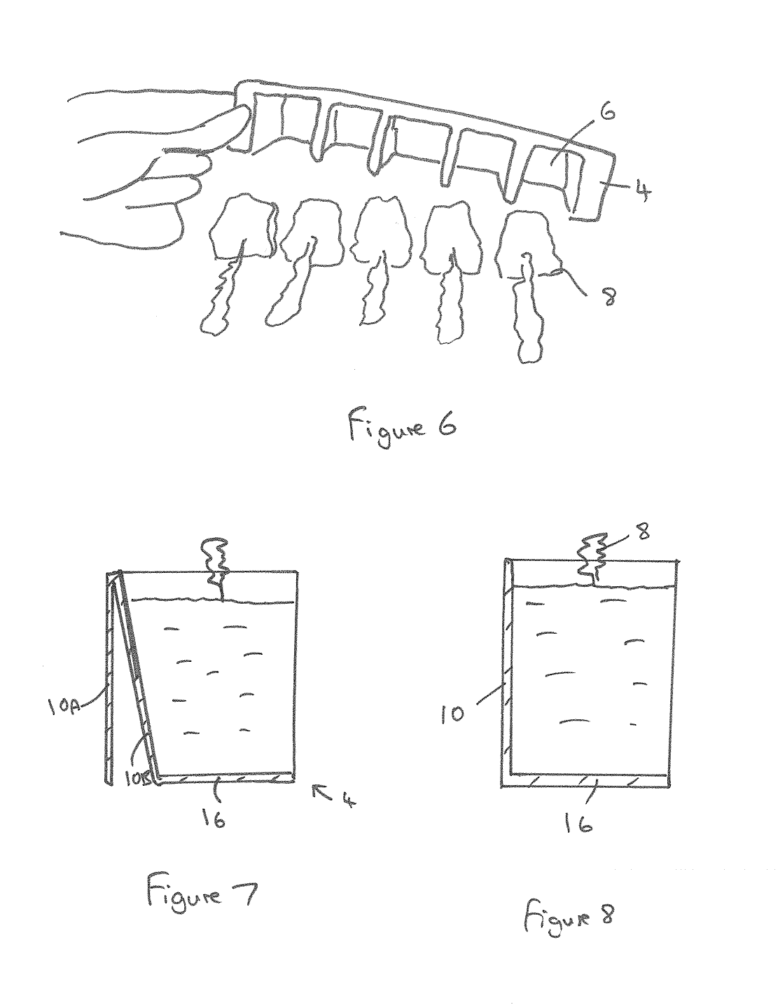

In an alternative embodiment, shown in FIG. 8, the first, second and side walls 10,12,14 of each cell may be arranged vertically so that each cell has a cuboid shape.

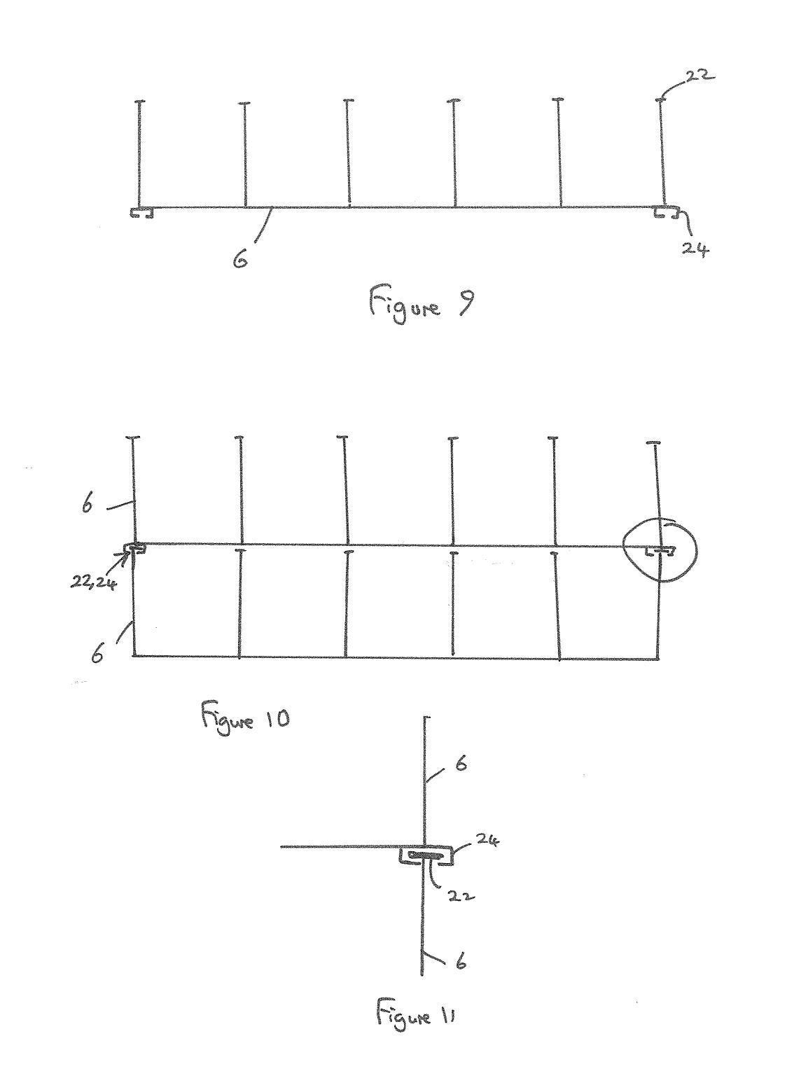

As illustrated in FIGS. 9 to 11, the inserts 6 may be adapted to be coupled to one another when placed in the support tray 2. In the embodiment shown, projections 22 are formed at a distal edge of outermost side wall of the end cells of each insert 6, said projections being receivable within female coupling members 24 integrally formed on the rear wall of the insert adjacent the outermost side walls thereof. It is envisaged that alternative coupling arrangement may be provided, including detachable clips.

The plant propagation tray of the present invention thereby greatly facilitates inspection of the seedlings during growth and facilitates quick and easy removal of the seedlings from the cells, when desired, without damage to the seedlings, thus overcoming the problems associated with the prior art.

The invention is not limited to the embodiments described herein but can be amended or modified without departing from the scope of the present invention.

What is claimed is:

1. A propagation tray assembly comprising a support tray and a plurality of seedling holder inserts locatable in the support tray in side by side relationship, each insert comprising a row of cells, each cell having an open top and an open side to facilitate inspection and removal of the contents thereof when the respective insert is removed from the support tray, wherein the open sides of the cells in a first insert are closed by the adjacent insert when the inserts are located in the support tray in side by side relationship.

2. A tray assembly as claimed in claim 1, wherein each cell of each insert comprises a first side wall, opposing second and third side walls extending perpendicular to the first side walls, the open side of each cell being located opposite said first side wall thereof.

3. A tray assembly as claimed in claim 2, wherein the first side walls of the cells of each insert are arranged in a respective common plane, the first side walls of each insert closing the open side of the cells of an adjacent insert when the inserts are located within the support tray.

4. A tray assembly as claimed in claim 3, wherein the first side walls of the cells in a respective insert are defined by a common wall extending the length of the respective insert, said common wall closing the open sides of the cells of an adjacent insert when the inserts are located in the support tray.

5. A tray assembly as claimed in claim 2, wherein the second and third side walls of the cells of each insert comprise partition walls separating the cells of each insert.

6. A tray assembly as claimed in claim 2, wherein said first, second and third walls of each cell are tapered towards a base wall thereof to allow a plurality of inserts to be stacked together.

7. A tray assembly as claimed in claim 6, wherein the first walls of the cells of each insert each comprise a tapered first wall portion defining a rear wall of the respective cell and a substantially vertical second wall portion depending from an upper edge of said first wall portion, said second wall portions of each insert being arranged to close the open side of the cells of an adjacent insert when the inserts are located within the support tray.

8. A tray assembly as claimed in claim 2, wherein the first, second and side walls of each cell are arranged substantially vertically so that each cell has a substantially cuboid shape.

9. A tray assembly as claimed in claim 1, wherein a drainage hole is provided in a base wall of each cell of each insert.

10. A tray assembly as claimed in claim 1, wherein each insert is releasably couplable to an adjacent insert.

11. A tray assembly as claimed in claim 10, wherein interlocking coupling devices are integrally formed on each insert to enable adjacent inserts to be coupled together.

12. A tray assembly as claimed in claim 10, wherein clips or other fastening device are provided for coupling adjacent inserts to one another.

13. A tray assembly as claimed in claim 4, wherein the second and third side walls of the cells of each insert comprise partition walls separating the cells of each insert.

14. A tray assembly as claimed in claim 4, wherein said first, second and third walls of each cell are tapered towards a base wall thereof to allow a plurality of inserts to be stacked together.

15. A tray assembly as claimed in claim 13, wherein said first, second and third walls of each cell are tapered towards a base wall thereof to allow a plurality of inserts to be stacked together.

16. A tray assembly as claimed in claim 2, wherein the first, second and side walls of each cell are arranged substantially vertically so that each cell has a substantially cuboid shape.
